(19) United States
(12) Patent Application Publication
(10) Pub. No.: US 2019/0345387 A1
(43) Pub. Date: Nov. 14, 2019

(54) LIQUID-CRYSTAL COMPOSITION AND LIQUID-CRYSTAL DISPLAY DEVICE EMPLOYING THE SAME

(71) Applicant: DAXIN MATERIALS CORPORATION, Taichung City (TW)

(72) Inventors: Chih-Yuan LO, Taichung City (TW); Chen Wang, Taichung City (TW); Chun-Chih Wang, Taichung City (TW)

(21) Appl. No.: 16/393,101

(22) Filed: Apr. 24, 2019

(30) Foreign Application Priority Data
May 9, 2018 (TW) 107115734

(51) Int. Cl. C09K 19/30; C09K 19/18; C09K 19/34; C09K 19/32

(52) U.S. Cl. CPC C09K 19/3003; C09K 19/18; C09K 19/3402; C09K 19/32; C09K 2019/181; C09K 2019/0466; C09K 2019/3025; C09K 2019/3024; C09K 2019/3022; C09K 2019/3425; C09K 2019/3007

(57) ABSTRACT

A liquid-crystal composition and a liquid-crystal display device employing the liquid-crystal composition are provided. The liquid-crystal composition includes a first component and a second component. The first component includes one or more compounds represented by Formula (I), and the second component includes one or more compounds represented by Formula (II):

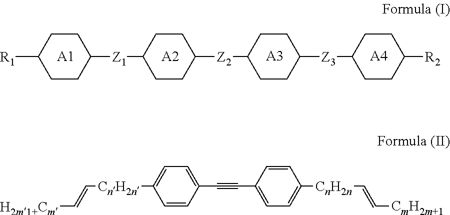

wherein R1, R2, A1, A2, A3, A4, Z1, Z2, Z3, m, m′, n, and n′ are defined as in the specification.

### CROSS REFERENCE TO RELATED APPLICATIONS

This application claims priority of Taiwan Application No. 107115734, filed May 9, 2018, the entirety of which is incorporated by reference herein.

### BACKGROUND

### Technical Field

The present disclosure relates to a liquid-crystal composition and a liquid-crystal display device that includes the liquid-crystal composition.

### Description of the Related Art

Liquid-crystal displays are widely used in various devices, such as personal computers, personal digital assistants (PDA), cell phones, and televisions, because of their small size, light weight, low power consumption, and excellent display quality.

The liquid-crystal material used in a liquid-crystal display should have a high dielectric anisotropy (Δε) and a low rotational viscosity (γ1) to meet present requirements. Particularly with high dielectric anisotropy, the liquid-crystal display may have a low threshold voltage (Vₜₕ) and thus achieve the object of power saving. When the liquid-crystal material has a lower rotational viscosity, the speed of response of the liquid-crystal molecule may be faster.

In addition, is crucial as well to the liquid-crystal material used in a liquid-crystal display to have good light stability and low-temperature storage stability. When liquid-crystal material has a good light stability and low-temperature storage stability, it will help maintain the quality of the material under different circumstances, and the quality and performance of a liquid-crystal display device using such a material will be more stable as well.

### SUMMARY

In accordance with some embodiments of the present disclosure, a liquid-crystal composition is provided. The liquid-crystal composition includes a first component and a second component, wherein the first component comprises one or more compounds represented by Formula (I) and the second component comprises one or more compounds represented by Formula (II):

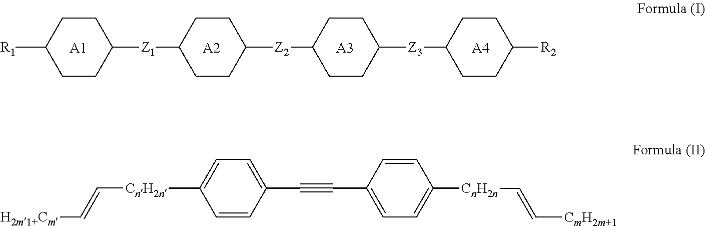

wherein R₁ and R₂ are independently F, a C₁-C₁₀ alkyl group, a C₁-C₁₀ alkoxy group, a C₂-C₁₀ alkenyl group, a C₂-C₁₀ alkenyloxy, or a C₂-C₁₀ alkynyl group, where the C₁-C₁₀ alkyl group, the C₁-C₁₀ alkoxy group, the C₂-C₁₀ alkenyl group, the C₂-C₁₀ alkenyloxy, or the C₂-C₁₀ alkynyl group is unsubstituted or at least one —CH₂— thereof is substituted by —O—, —NH—, —S—, —CO—, —O—CO—, —CO—O— or —O—CO—O—, provided that the —O—, —NH—, —S—, —CO—, —O—CO—, —CO—O— or —O—CO—O— do not directly bond to one another, and/or at least one hydrogen of the C₁-C₁₀ alkyl group, the C₁-C₁₀ alkoxy group, the C₂-C₁₀ alkenyl group, the C₂-C₁₀ alkenyloxy, or the C₂-C₁₀ alkynyl group is unsubstituted or substituted by halogen, CN, or CF₃. Each of A1, A2, A3, and A4 independently represents (i) an unsubstituted

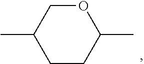

(ii) a substituted

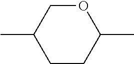

where at least one —CH₂— thereof is substituted by —O—, —NH—, —S—, —CO—, —O—CO—, —CO—O— or —O—CO—O— and the —O—, —NH—, —S—, —CO—, —O—CO—, —CO—O— or —O—CO—O— do not directly bond to one another, (iii) a substituted

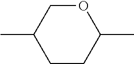

where at least one hydrogen thereof is substituted by halogen, CN, or CF₃, (iv) an unsubstituted

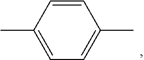

(v) a substituted

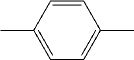

where at least one hydrogen thereof is substituted by halogen, CH₃, CN, or CF₃, (vi) a substituted

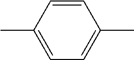

where at least one —CH— thereof is substituted by —N—, (vii) an unsubstituted

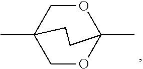

and/or (viii) a substituted

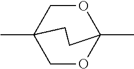

where at least one —CH₂— thereof is substituted by —O—, —NH—, —S—, —CO—, —O—CO—, —CO—O— or —O—CO—O— and the —O—, —NH—, —S—, —CO—, —O—CO—, —CO—O— or —O—CO—O— do not directly bond to one another; A1, A2, A3, and A4 are the same or different. Each of Z₁, Z₂, and Z₃ independently represents a single bond, —CF₂—O—, —O—CF₂—, —CO—O—, or —O—CO—, and at least one of Z₁, Z₂, and Z₃ is —CF₂—O— or —O—CF₂—; and each of the m, m′, n and n′ independently represents an integer from 0 to 6, wherein the m, m′, n and n′ are the same or different.

In accordance with some embodiments of the present disclosure, a liquid-crystal device is provided. The liquid-crystal display device includes a first substrate, a second substrate disposed opposite the first substrate, and a liquid-crystal layer disposed between the first substrate and the second substrate. The liquid-crystal layer includes the liquid-crystal composition mentioned above.

To further simplify and clarify the foregoing contents and other objects, characteristics, and merits of the present disclosure, a detailed description is given in the following embodiments.

### DETAILED DESCRIPTION

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In present disclosure, a range represented by “from ‘a numeral’ to ‘a numeral’” is a brief form, which is used to avoid redundantly reciting every numeral in the range. Thus, when a specific range is recited, it is considered to recite any numerals in the specific range and any smaller ranges defined by any numerals in the specific range, just as expressly reciting the any numerals and the any smaller ranges. For example, a recited range “the content is from 10% to 80%” discloses a range “the content is from 20% to 40%” as well, no matter other numeral is recited in the disclosure or not.

The present disclosure provides a liquid-crystal composition. In some embodiments, the liquid-crystal composition may keep a high dielectric anisotropy (Δε) and a low rotational viscosity (γ1) and simultaneously raise the light stability and/or the low-temperature storage stability. Therefore, when the liquid-crystal composition provided by the present invention is applied to a liquid-crystal display, not only can the purpose of saving power and increasing the response speed be achieved, but also the liquid-crystal display using the composition will have a more stable quality and performance.

In some embodiments, the present disclosure provides a liquid-crystal composition, including about 0.1-35 wt % of a first component and about 0.1-20 wt % of a second component, and the total weight of the liquid-crystal composition is defined as 100 wt %. In some embodiments, using the total weight of the liquid-crystal composition as 100 wt %, a range of the first component may be about 1-30 wt %, such as 5-25 wt %. In some embodiments, based on the total weight of the liquid-crystal composition (100 wt %), a range of the second component may be about 1-15 wt %, such as 1.5-14 wt %. The main function of the first component and the second component is adjusting the dielectric anisotropy (Δε) and the rotational viscosity (γ1) to a desired range. For example, in some embodiments, the dielectric anisotropy (Δε) is adjusted to be greater than 2.

In some embodiments, the first component of the liquid-crystal composition may include one or more compounds represented by Formula (I):

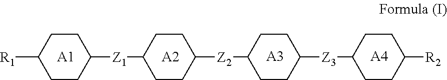

wherein R₁ and R₂ are independently F, a C₁-C₁₀ alkyl group, a C₁-C₁₀ alkoxy group, a C₂-C₁₀ alkenyl group, a C₂-C₁₀ alkenyloxy, or a C₂-C₁₀ alkynyl group, wherein the C₁-C₁₀ alkyl group, the C₁-C₁₀ alkoxy group, the C₂-C₁₀ alkenyl group, the C₂-C₁₀ alkenyloxy, or the C₂-C₁₀ alkynyl group is unsubstituted or at least one —CH₂— thereof is substituted by —O—, —NH—, —S—, —CO—, —O—CO—, —CO—O— or —O—CO—O—, provided that the —O—, —NH—, —S—, —CO—, —O—CO—, —CO—O— or —O—CO—O— do not directly bond to one another, and/or at least one hydrogen of the C₁-C₁₀ alkyl group, the C₁-C₁₀ alkoxy group, the C₂-C₁₀ alkenyl group, the C₂-C₁₀ alkenyloxy, or the C₂-C₁₀ alkynyl group is unsubstituted or substituted by halogen, CN, or CF₃; each of A1, A2, A3, and A4 independently represents (i) an unsubstituted

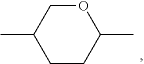

(ii) a substituted

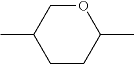

where at least one —CH₂— thereof is substituted by —O—, —NH—, —S—, —CO—, —O—CO—, —CO—O— or —O—CO—O— and the —O—, —NH—, —S—, —CO—, —O—CO—, —CO—O— or —O—CO—O— do not directly bond to one another, (iii) a substituted

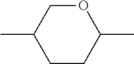

where at least one hydrogen thereof is substituted by halogen, CN, or CF₃, (iv) an unsubstituted

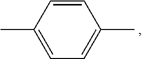

(v) a substituted

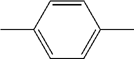

where at least one hydrogen thereof is substituted by halogen, CH₃, CN, or CF₃, (vi) a substituted

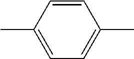

where at least one —CH— thereof is substituted by —N—, (vii) an unsubstituted

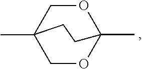

and/or (viii) a substituted

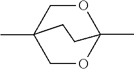

where at least one —CH₂— thereof is substituted by —O—, —NH—, —S—, —CO—, —O—CO—, —CO—O— or —O—CO—O— and the —O—, —NH—, —S—, —CO—, —O—CO—, —CO—O— or —O—CO—O— do not directly bond to one another. A1, A2, A3, and A4 may be the same or different. Each of Z₁, Z₂, and Z₃ independently represents a single bond, —CF₂—O—, —O—CF₂—, —CO—O—, or —O—CO—, and at least one of Z₁, Z₂, and Z₃ is —CF₂—O— or —O—CF₂—. When at least one of Z₁, Z₂, and Z₃ in the liquid-crystal composition is —CF₂—O— or —O—CF₂—, the liquid-crystal composition thus formed may possess higher dielectric anisotropy and a lower rotational viscosity.

In some embodiments, the first component only contains one compound represented by the aforementioned Formula (I), and at least one of Z₁, Z₂, and Z₃ of the compound is —CF₂—O— or —O—F₂—.

In some embodiments, when Z₁, Z₂, or Z₃ is a single bond, it means that two groups at the terminals of the Z₁, Z₂, or Z₃ are directly bonded each other.

In some embodiments, the first component may include two or more compounds represented by Formula (I).

In the liquid-crystal composition, the second component may include one or more compounds represented by Formula (II):

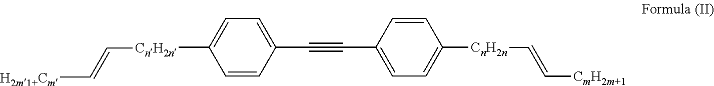

wherein each of the m, m′, n and n′ independently represents an integer from 0 to 6, wherein the m, m′, n and n′ may be the same or different from each other.

When the liquid-crystal composition simultaneously includes the first component and the second component, and at least one of the Z1, Z2, and Z3 of the first component represented by Formula (I) is —CF₂—O— or —O—CF₂—; the second component has the structure of Formula (II), the liquid-crystal composition thus formed may possess higher dielectric anisotropy, a lower rotational viscosity and better light stability. Therefore, the dielectric anisotropy, rotational viscosity and light stability can be adjusted to a desired range by properly choosing the structure units, Z₁, Z₂, and Z₃, of the first component represented by Formula (I).

In some embodiments, the liquid-crystal composition provided in the present disclosure may further include at least one component selected from a group consisting of a third component, a fourth component and a fifth component.

In some embodiments, the liquid-crystal composition provided in the present disclosure may further include about 0-65 wt % of the third component, preferably 10-65 wt %, more preferably 42-65 wt %, which are calculated based on the total weight of the liquid-crystal composition (100 wt %). In some embodiments, using the total weight of the liquid-crystal composition as 100 wt %, the third component may be about 10-65 wt %, such as 30-62 wt %. The third component may include one or more compounds represented by Formula (III):

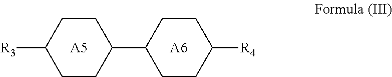

wherein each of R₃ and R₄ independently represents F, a C₁-C₁₀ alkyl group, a C₁-C₁₀ alkoxy group, a C₂-C₁₀ alkenyl group, a C₂-C₁₀ alkenyloxy, or a C₂-C₁₀ alkynyl group, where the C₁-C₁₀ alkyl group, the C₁-C₁₀ alkoxy group, the C₂-C₁₀ alkenyl group, the C₂-C₁₀ alkenyloxy, or the C₂-C₁₀ alkynyl group is unsubstituted or at least one —CH₂— thereof is substituted by —O—, —NH—, —S—, —CO—, —O—CO—, —CO—O— or —O—CO—O—, provided that the —O—, —NH—, —S—, —CO—, —O—CO—, —CO—O— or —O—CO—O— do not directly bond to one another, and/or at least one hydrogen of the C₁-C₁₀ alkyl group, the C₁-C₁₀ alkoxy group, the C₂-C₁₀ alkenyl group, the C₂-C₁₀ alkenyloxy, or the C₂-C₁₀ alkynyl group is unsubstituted or substituted by halogen, CN, or CF₃; each of A5 and A6 independently represents (i) an unsubstituted

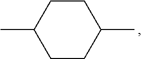

(ii) a substituted

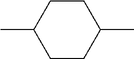

where at least one —CH₂— thereof is substituted by —O—, —NH—, —S—, —CO—, —O—CO—, —CO—O— or —O—CO—O— and the —O—, —NH—, —S—, —CO—, —O—CO—, —CO—O— or —O—CO—O— do not directly bond to one another, (iii) an unsubstituted

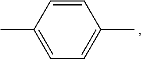

(iv) a substituted

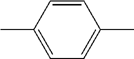

where at least one hydrogen thereof is substituted by halogen, CH₃, CN, or CF₃, (v) a substituted

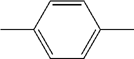

where at least one —CH— thereof is substituted by —N—, (vi) an unsubstituted

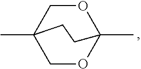

and/or (vii) a substituted

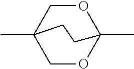

where at least one —CH₂— thereof is substituted by —O—, —NH—, —S—, —CO—, —O—CO—, —CO—O— or —O—CO— and the —O—, —NH—, —S—, —CO—, —O—CO—, —CO—O— or —O—CO—O— do not directly bond to one another. A5 and A6 may be the same or different.

In some embodiments, when the liquid-crystal composition contains the third component, the liquid-crystal composition thus formed may further possess lower rotational viscosity.

In some embodiments, the third component may be

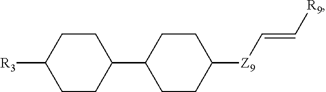

wherein R₉ is C₁-C₆ alkyl group, Z₉ is a single bond, —(CH₂)₂—, or —CH₂—; or at least one of A5 and A6 of Formula (III) is an unsubstituted

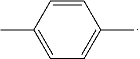

In some other embodiments, the third component may contain two or more compounds represented by the Formula (III). When the third component contains two or more compounds represented by the Formula (III), the liquid-crystal composition thus formed may further possess better light stability. For example, in some embodiments, the third component contains at least one compound represented by Formula (III), wherein at least one of A5 and A6 of Formula (III) is an unsubstituted

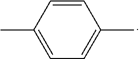

In such cases, the liquid-crystal composition thus formed may possess better light stability.

In some embodiments, the liquid-crystal composition provided in the present disclosure may further include about 0-50 wt % of the fourth component, which is calculated based on the total weight of the liquid-crystal composition (100 wt %). In some embodiments, based on the total weight of the liquid-crystal composition (100 wt %), the fourth component may be about 5-50 wt %, such as 10-40 wt %. The fourth component may include one or more compounds represented by Formula (IV):

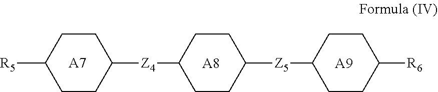

wherein each of R₅ and R₆ independently represents F, a C₁-C₁₀ alkyl group, a C₁-C₁₀ alkoxy group, a C₂-C₁₀ alkenyl group, a C₂-C₁₀ alkenyloxy, or a C₂-C₁₀ alkynyl group, where the C₁-C₁₀ alkyl group, the C₁-C₁₀ alkoxy group, the C₂-C₁₀ alkenyl group, the C₂-C₁₀ alkenyloxy, or the C₂-C₁₀ alkynyl group is unsubstituted or at least one —CH₂— thereof is substituted by —O—, —NH—, —S—, —CO—, —O—CO—, —CO—O— or —O—CO—O—, provided that the —O—, —NH—, —S—, —CO—, —O—CO—, —CO—O— or —O—CO—O— do not directly bond to one another, and/or at least one hydrogen of the C₁-C₁₀ alkyl group, the C₁-C₁₀ alkoxy group, the C₂-C₁₀ alkenyl group, the C₂-C₁₀ alkenyloxy, or the C₂-C₁₀ alkynyl group is unsubstituted or substituted by halogen, CN, or CF₃; each of A7, A8 and A9 independently represents (i) an unsubstituted

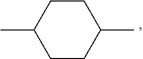

(ii) a substituted

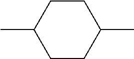

where at least one —CH₂— thereof is substituted by —O—, —NH—, —S—, —CO—, —O—CO—, —CO—O— or —O—CO—O— and the —O—, —NH—, —S—, —CO—, —O—CO—, —CO—O— or —O—CO—O— do not directly bond to one another, (iii) a substituted

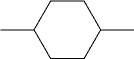

where at least one hydrogen thereof is substituted by halogen, CN, or CF₃, (iv) an unsubstituted

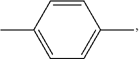

(v) a substituted

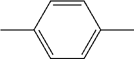

where at least one hydrogen is substituted by halogen, CH₃, CN, or CF₃, (vi) a substituted

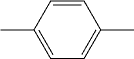

where at least one —CH— thereof is substituted by —N—, (vii) an unsubstituted

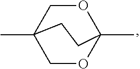

(viii) a substituted

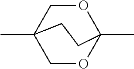

where at least one —CH₂— is substituted by —O—, —NH—, —S—, —CO—, —O—CO—, —CO—O— or —O—CO—O— and the —O—, —NH—, —S—, —CO—, —O—CO—, —CO—O— or —O—CO—O— do not directly bond to one another, (viiii) a substituted

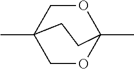

where at least one hydrogen thereof is substituted by halogen, CN, or CF₃, and/or (x) an unsubstituted

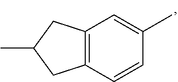

(xi) a substituted

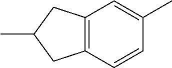

where at least one —CH₂— thereof is substituted by —O—, —NH—, —S—, —CO—, —O—CO—, —CO—O— or —O—CO—O— and the —O—, —NH—, —S—, —CO—, —O—CO—, —CO—O— or —O—CO—O— do not directly bond to one another, and/or (xii) a substituted

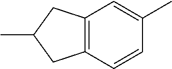

where at least one hydrogen thereof is substituted by halogen, CN, or CF₃, wherein A7, A8, A9, A10, A11, A12, and A13 are the same or different. Each of Z₄ and Z₅ independently represents a single bond, a double bond, a triple bond, —(CH₂)₂—, —CF₂—O—, —O—CF₂—, —CO—O—, or —O—CO—.

In some embodiments, when Z₄ or Z₅ is a single bond, it means that the functional groups connected to the terminals of the Z₄ or Z₅ are directly bonded.

In some embodiments, the liquid-crystal composition provided in the present disclosure may further include about 0-15 wt % of the fifth component, which is calculated based on the total weight of the liquid-crystal composition (100 wt %). In some embodiments, based on the total weight of the liquid-crystal composition (100 wt %), the fifth component may be about 1-15 wt %, such as 2-14 wt %. The fifth component may include one or more compounds represented by Formula (V):

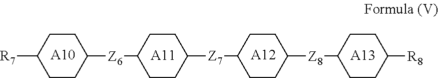

wherein each of R₇ and R₈ independently represents F, a C₁-C₁₀ alkyl group, a C₁-C₁₀ alkoxy group, a C₂-C₁₀ alkenyl group, a C₂-C₁₀ alkenyloxy, or a C₂-C₁₀ alkynyl group, where the C₁-C₁₀ alkyl group, the C₁-C₁₀ alkoxy group, the C₂-C₁₀ alkenyl group, the C₂-C₁₀ alkenyloxy, or the C₂-C₁₀ alkynyl group is unsubstituted or at least one —CH₂— thereof is substituted by —O—, —NH—, —S—, —CO—, —O—CO—, —CO—O— or —O—CO—O—, provided that the —O—, —NH—, —S—, —CO—, —O—CO—, —CO—O— or —O—CO—O— do not directly bond to one another, and/or at least one hydrogen of the C₁-C₁₀ alkyl group, the C₁-C₁₀ alkoxy group, the C₂-C₁₀ alkenyl group, the C₂-C₁₀ alkenyloxy, or the C₂-C₁₀ alkynyl group is unsubstituted or substituted by halogen, CN, or CF₃; each of A10, A11, A12 and A13 independently represents (i) an unsubstituted

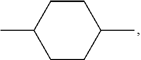

(ii) a substituted

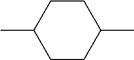

where at least one —CH₂— thereof is substituted by —O—, —NH—, —S—, —CO—, —O—CO—, —CO—O— or —O—CO—O— and the —O—, —NH—, —S—, —CO—, —O—CO—, —CO—O— or —O—CO—O— do not directly bond to one another, (iii) a substituted

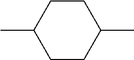

where at least one hydrogen thereof is substituted by halogen, CN, or CF₃, (iv) an unsubstituted

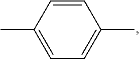

(v) a substituted

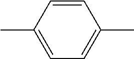

where at least one hydrogen is substituted by halogen, CH₃, CN, or CF₃, (vi) a substituted

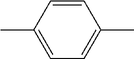

where at least one —CH— thereof is substituted by —N—, (vii) an unsubstituted

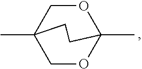

(viii) a substituted

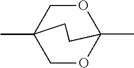

where at least one —CH₂— is substituted by —O—, —NH—, —S—, —CO—, —O—CO—, —CO—O— or —O—CO—O— and the —O—, —NH—, —S—, —CO—, —O—CO—, —CO—O— or —O—CO—O— do not directly bond to one another, (viiii) a substituted

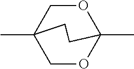

where at least one hydrogen thereof is substituted by halogen, CN, or CF₃, and/or (x) an unsubstituted

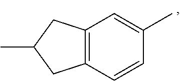

(xi) a substituted

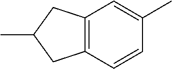

where at least one —CH₂— thereof is substituted by —O—, —NH—, —S—, —CO—, —O—CO—, —CO—O— or —O—CO—O— and the —O—, —NH—, —S—, —CO—, —O—CO—, —CO—O— or —O—CO—O— do not directly bond to one another, and/or (xii) a substituted

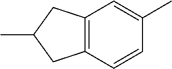

where at least one hydrogen thereof is substituted by halogen, CN, or CF₃, wherein A10, A11, A12, and A13 are the same or different. Each of Z₆, Z₇ and Z₈ independently represents a single bond, a double bond, a triple bond, —(CH₂)₂—, —CF₂—O—, —O—CF₂—, —CO—O—, or —O—CO—. When one of Z₆, Z₇ and Z₈ is —CF₂—O— or —O—CF₂—, one of A10, A11, A12, and A13 is (i) an unsubstituted

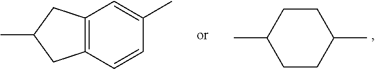

(ii) a substituted

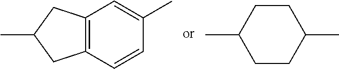

where at least one —CH₂— thereof is substituted by —O—, —NH—, —S—, —CO—, —O—CO—, —CO—O— or —O—CO—O— and the —O—, —NH—, —S—, —CO—, —O—CO—, —CO—O— or —O—CO—O— do not directly bond to one another, or (iii) a substituted

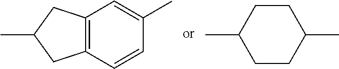

or where at least one hydrogen thereof is substituted by halogen, CN, or CF₃.

In some embodiments, when Z₆, Z₇ or Z₈ is a single bond, it means that the groups at the terminals of the Z₆, Z₇ or Z₈ are directly bonded.

In some embodiments, at least one A10, A11, A12 and A13 in one or more compounds represented by Formula (V) is

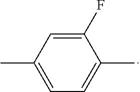

When at least one A10, A11, A12 and A13 in the compounds represented by Formula (V) is

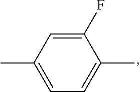

the liquid-crystal composition thus formed may further possess better low-temperature storage stability. Therefore, the low-temperature storage stability can be adjusted to the desired range by properly choosing the structure units, A10, A11, A12 and A13, of the compound represented by Formula (V).

The person skilled in the art should understand that a suitable amount of additive may be further included in the liquid-crystal composition as long as the performance of the liquid-crystal composition will not be negatively affected. For instance, the additive may be a chiral dopant, a UV stabilizer, an anti-oxidant, a free radical scavenger, or nanoparticles.

In some embodiments, the dielectric anisotropy (Δε) of the liquid-crystal composition provided in the present disclosure may be greater than 2 and the rotational viscosity (γ1) may be smaller than 70. In addition, the liquid-crystal composition provided in the present disclosure possesses a stable voltage retention rate. For example, the difference between the voltage holding ratio of the liquid-crystal composition before being exposed to UV light and the voltage holding ratio of the liquid-crystal composition after being exposed to UV light may be less than about 15% of the original voltage holding ratio. In some embodiments, the storage period of the liquid-crystal composition provided in the present disclosure at −30° C. may be longer than 1 day, or even up to 25 days.

In some other embodiments, the present disclosure provides a liquid-crystal display device, which includes a first substrate, a second substrate disposed opposite the first substrate, and a liquid-crystal layer disposed between the first substrate and the second substrate. The liquid-crystal layer includes the liquid-crystal composition mentioned previously.

Since various liquid-crystal compositions will be described below, the liquid-crystal compositions will be represented by combinations of code names below for brevity. For example, the oxygen atom is represented by the code name O, and the fluorine atom is represented by the code name F. The structure units and their corresponding code names are listed in Table 1.

TABLE 1

| | |
|---|---|
| P | 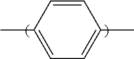 |
| G | 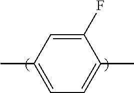 |
| U | 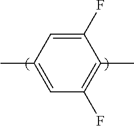 |
| C | 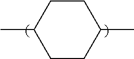 |
| Q | 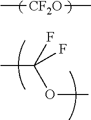 |
| A | 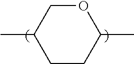 |
| UF | 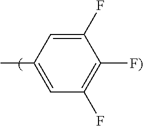 |
| T | C≡C |
| V | CH═CH₂) |
| V1 | CH═CH—CH₃) |
| O2F | 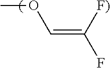 |
| CF3 | CF₃) |
| KF | 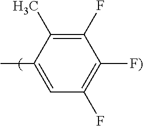 |
| GF | 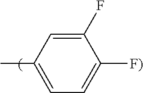 |
| RI | 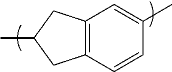 |
| do | 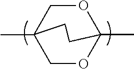 |
| to | 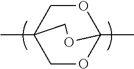 |
| D | 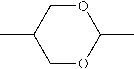 |

In the present disclosure, a normal-sized number represents an alkyl group with carbon atoms equal to the number. For example, the code name 3CCV represents the compound having a C₃ alkyl group, the structure unit C, the structure unit C, and the structure unit V, from the leftmost end to the rightmost end sequentially. In other words, the code name 3CCV represents the following compound:

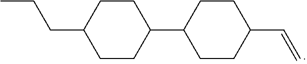 [SMILES: C=CC1CCC(C2CCC(CCC)CC2)CC1]

In addition, the code names are combined directly according to the position and direction as shown in Table 1. For example, the code name 3PGUQUF represents the following compound:

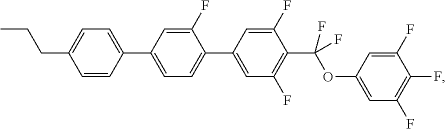 [SMILES: CCCc1ccc(-c2ccc(-c3cc(F)c(C(F)(F)Oc4cc(F)c(F)c(F)c4)c(F)c3)c(F)c2)cc1]

but not

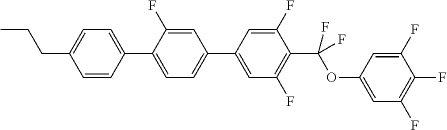 [SMILES: CCCc1ccc(-c2ccc(-c3cc(F)c(C(F)(F)Oc4cc(F)c(F)c(F)c4)c(F)c3)cc2F)cc1]

The liquid-crystal composition provided in the present disclosure includes a first component, wherein the first component may contain one or more compounds represented by Formula (I). For example, the first component may include 3PGUQUF, 4PGUQUF, 5PGUQUF, 3PGUQKF, 3APUQKF, 5doPUQUF, 3APUQUF, 3DPUQUF, 3PGGQUF, 3PGUQGF. In some embodiments, the structure unit Q (—CF₂O—) may be replaced with —OCF₂—.

The liquid-crystal composition provided in the present disclosure further includes a second component, wherein the first component may contain one or more compounds represented by Formula (II). For example, the second component may include V2PTP2V or 1V2PTP2V.

The liquid-crystal composition provided in the present disclosure may further include a third component, wherein the third component may contain one or more compounds represented by Formula (III). For example, the third component may include 5PP1, 3CPO2, 3CC2, 3CC4, 3CC5, 3CCV, 3CCV1, 5CCV, 3CCV, 1CCV, 2CCV, 1CCV1, 2CCV1, 3PPO2, or V2PP1.

The liquid-crystal composition provided in the present disclosure may further include a fourth component, wherein the fourth component may contain one or more compounds represented by Formula (IV). For example, the fourth component may include 3PUQKF, 2toUQUO2F, 2doPUO2F, 3doPUO2F, 2CPGF, 3CPGF, 5CPGF, VCCGF, 2CCGF, 3CCGF, 5CCGF, 2CCUF, 3CCUF, 5CCUF, 3CCPOCF3, 5CCPOCF3, 3CPPF, 3CPP2, 4CCP3, 3CPTP2, 3PUQUF, 3CCQUF, VCCP1, 3PGUF, or 3CGUF.

The liquid-crystal composition provided in the present disclosure may further include a fifth component, wherein the fifth component may contain one or more compounds represented by Formula (V). For example, the fifth component may include 3CCPGF, 5CCPGF, 3RIGUQUF, 3CPPC3, 3CPGUF, 3PGGUF, 3CGPC3, 3CGUQUF, 3CCUQUF, 5CGUQUF, or 5CCUQUF.

As mentioned previously, in the liquid-crystal composition provided in the present disclosure, each of the first, second, third, fourth and fifth component has its own characteristics and functions. Therefore, the dielectric anisotropy (Δε), rotational viscosity (γ1), light stability and/or low-temperature storage stability of the liquid-crystal composition may be adjusted to the desired range by choosing the appropriate first, second, third, fourth and fifth component and adjusting the contents of each component. The liquid-crystal composition may keep a high dielectric anisotropy (Δε) and a low rotational viscosity (γ1) while simultaneously effectively raising the light stability and/or low-temperature storage stability. Therefore, when utilizing the liquid-crystal composition provided in the present disclosure in a liquid-crystal display device, not only the object of power saving and enhancing the speed of response of the liquid-crystal display device may be achieved, but also the liquid-crystal display device using the material will have a more stable quality and performance.

The liquid-crystal composition provided in the present disclosure may be applied to various kinds of display devices, such as Twisted nematic-Liquid-crystal display (TN-LCD), Super twisted nematic-Liquid-crystal display (STN-LCD), or Thin film transistor liquid-crystal display (TFT-LCD).

Below, Examples and Comparative Examples are provided to explain the characteristics of the liquid-crystal compositions and the liquid-crystal display devices provided in the present disclosure.

Since many liquid-crystal compositions will be mentioned in the following Examples and Comparative Examples, the liquid-crystal compositions will be represented by combinations of code names below for clarity of discussion. The structure unit that each of the code names represents is shown in the aforementioned Table 1. The chemical structure that each code name of the liquid-crystal compositions represents is shown in Table 2 below.

TABLE 2

| | Code name | Chemical structure |
|---|---|---|
| Formula(I) | 3PGUQUF | 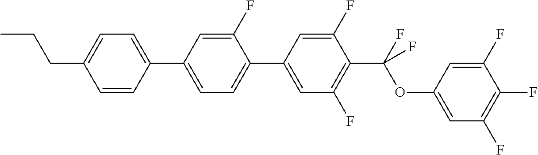 [SMILES: CCCc1ccc(-c2ccc(-c3cc(F)c(C(F)(F)Oc4cc(F)c(F)c(F)c4)c(F)c3)c(F)c2)cc1] |
| | 4PGUQUF | 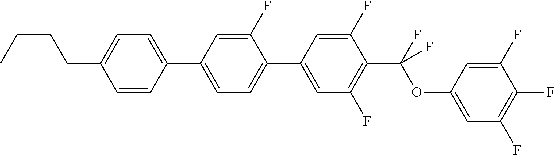 [SMILES: CCCCc1ccc(-c2ccc(-c3cc(F)c(C(F)(F)Oc4cc(F)c(F)c(F)c4)c(F)c3)c(F)c2)cc1] |
| | 5PGUQUF | 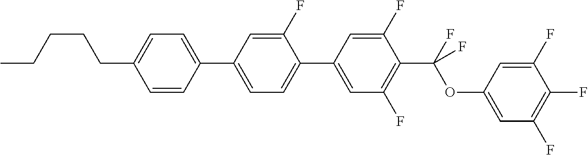 [SMILES: CCCCCc1ccc(-c2ccc(-c3cc(F)c(C(F)(F)Oc4cc(F)c(F)c(F)c4)c(F)c3)c(F)c2)cc1] |
| | 3PGUQKF | 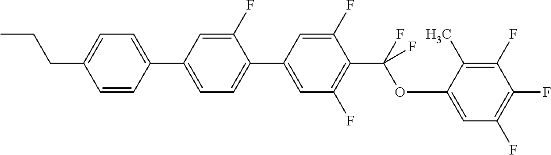 [SMILES: CCCc1ccc(-c2ccc(-c3cc(F)c(C(F)(F)Oc4cc(F)c(F)c(F)c4C)c(F)c3)c(F)c2)cc1] |
| | 3APUQKF | 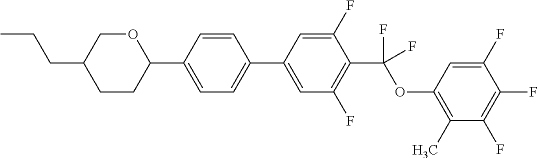 [SMILES: CCCC1CCC(c2ccc(-c3cc(F)c(C(F)(F)Oc4cc(F)c(F)c(F)c4C)c(F)c3)cc2)OC1] |
| | 5doPUQUF | 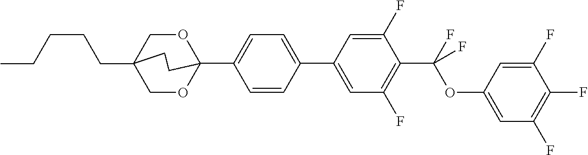 [SMILES: CCCCCC12CCC(c3ccc(-c4cc(F)c(C(F)(F)Oc5cc(F)c(F)c(F)c5)c(F)c4)cc3)(OC1)OC2] |
| Formula(II) | V2PTP2V | 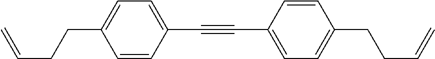 [SMILES: C=CCCc1ccc(C#Cc2ccc(CCC=C)cc2)cc1] |
| Other component | 1PTPO2 | 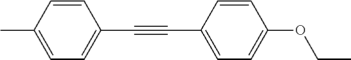 [SMILES: CCOc1ccc(C#Cc2ccc(C)cc2)cc1] |
| | 3PTPO1 | 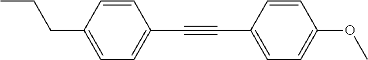 [SMILES: CCCc1ccc(C#Cc2ccc(OC)cc2)cc1] |
| | 3PTPO2 | 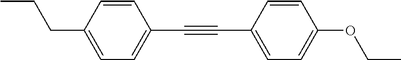 [SMILES: CCCc1ccc(C#Cc2ccc(OCC)cc2)cc1] |
| Formula(III) | 5PP1 | 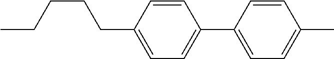 [SMILES: CCCCCc1ccc(-c2ccc(C)cc2)cc1] |
| | 3CPO2 | 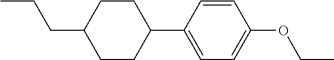 [SMILES: CCCC1CCC(c2ccc(OCC)cc2)CC1] |
| | 3CC2 | 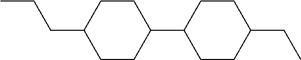 [SMILES: CCCC1CCC(C2CCC(CC)CC2)CC1] |
| | 3CCV1 | 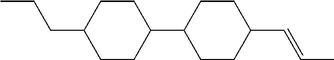 [SMILES: C/C=C/C1CCC(C2CCC(CCC)CC2)CC1] |
| | 5CCV | 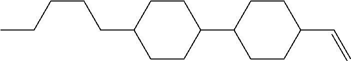 [SMILES: C=CC1CCC(C2CCC(CCCCC)CC2)CC1] |
| | 3CCV | 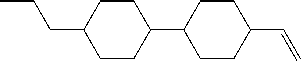 [SMILES: C=CC1CCC(C2CCC(CCC)CC2)CC1] |
| Formula(IV) | 3PUQKF | 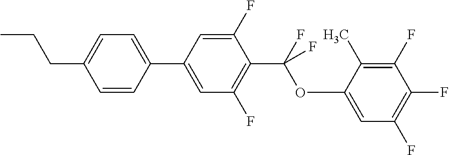 [SMILES: CCCc1ccc(-c2cc(F)c(C(F)(F)Oc3cc(F)c(F)c(F)c3C)c(F)c2)cc1] |
| | 2toUQUO2F | 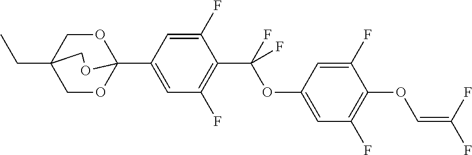 [SMILES: CCC12COC(c3cc(F)c(C(F)(F)Oc4cc(F)c(OC=C(F)F)c(F)c4)c(F)c3)(OC1)OC2] |
| | 2doPUO2F | 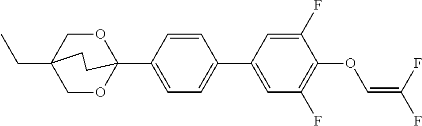 [SMILES: CCC12CCC(c3ccc(-c4cc(F)c(OC=C(F)F)c(F)c4)cc3)(OC1)OC2] |
| | 3doPUO2F | 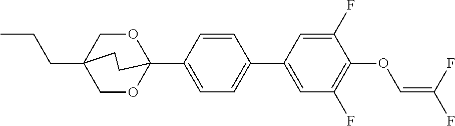 [SMILES: CCCC12CCC(c3ccc(-c4cc(F)c(OC=C(F)F)c(F)c4)cc3)(OC1)OC2] |
| | 2CPGF | 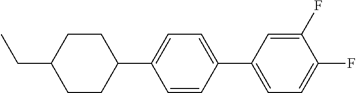 [SMILES: CCC1CCC(c2ccc(-c3ccc(F)c(F)c3)cc2)CC1] |
| | 3CPGF | 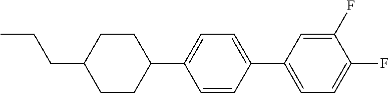 [SMILES: CCCC1CCC(c2ccc(-c3ccc(F)c(F)c3)cc2)CC1] |
| | 5CPGF | 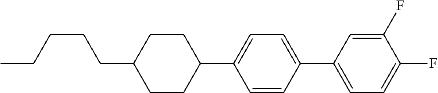 [SMILES: CCCCCC1CCC(c2ccc(-c3ccc(F)c(F)c3)cc2)CC1] |
| | VCCGF | 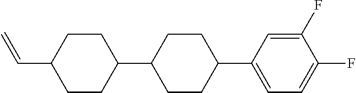 [SMILES: C=CC1CCC(C2CCC(c3ccc(F)c(F)c3)CC2)CC1] |
| | 2CCGF | 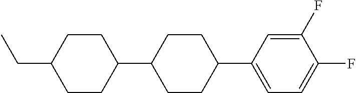 [SMILES: CCC1CCC(C2CCC(c3ccc(F)c(F)c3)CC2)CC1] |
| | 3CCGF | 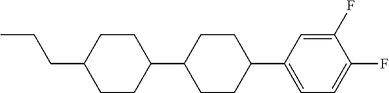 [SMILES: CCCC1CCC(C2CCC(c3ccc(F)c(F)c3)CC2)CC1] |
| | 5CCGF | 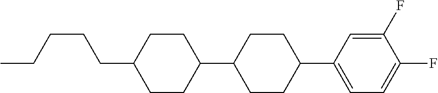 [SMILES: CCCCCC1CCC(C2CCC(c3ccc(F)c(F)c3)CC2)CC1] |
| | 2CCUF | 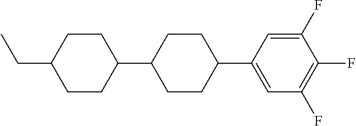 [SMILES: CCC1CCC(C2CCC(c3cc(F)c(F)c(F)c3)CC2)CC1] |
| | 3CCUF | 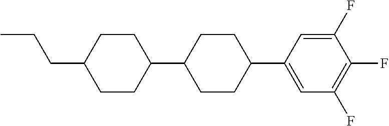 [SMILES: CCCC1CCC(C2CCC(c3cc(F)c(F)c(F)c3)CC2)CC1] |
| | 5CCUF | 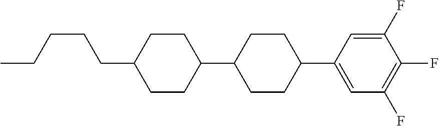 [SMILES: CCCCCC1CCC(C2CCC(c3cc(F)c(F)c(F)c3)CC2)CC1] |
| | 3CCPOCF3 | 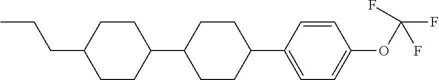 [SMILES: CCCC1CCC(C2CCC(c3ccc(OC(F)(F)F)cc3)CC2)CC1] |
| | 5CCPOCF3 | 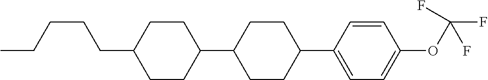 [SMILES: CCCCCC1CCC(C2CCC(c3ccc(OC(F)(F)F)cc3)CC2)CC1] |
| | 3CPPF | 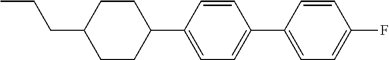 [SMILES: CCCC1CCC(c2ccc(-c3ccc(F)cc3)cc2)CC1] |
| | 3CPP2 | 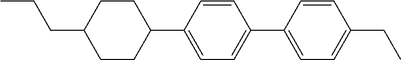 [SMILES: CCCC1CCC(c2ccc(-c3ccc(CC)cc3)cc2)CC1] |
| | 4CCP3 | 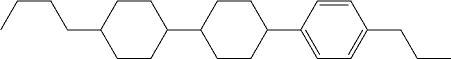 [SMILES: CCCCC1CCC(C2CCC(c3ccc(CCC)cc3)CC2)CC1] |
| | 3CPTP2 | 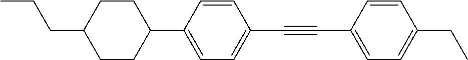 [SMILES: CCCC1CCC(c2ccc(C#Cc3ccc(CC)cc3)cc2)CC1] |
| Formula(V) | 3CCPGF | 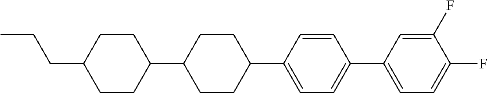 [SMILES: CCCC1CCC(C2CCC(c3ccc(-c4ccc(F)c(F)c4)cc3)CC2)CC1] |
| | 5CCPGF | 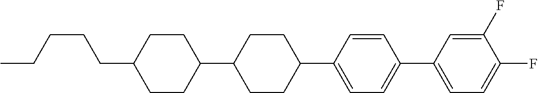 [SMILES: CCCCCC1CCC(C2CCC(c3ccc(-c4ccc(F)c(F)c4)cc3)CC2)CC1] |
| | 2RIGUQUF | 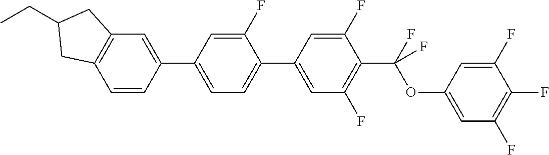 [SMILES: CCC1Cc2ccc(-c3ccc(-c4cc(F)c(C(F)(F)Oc5cc(F)c(F)c(F)c5)c(F)c4)c(F)c3)cc2C1] |
| | 3RIGUQUF | 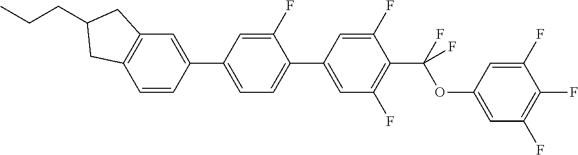 [SMILES: CCCC1Cc2ccc(-c3ccc(-c4cc(F)c(C(F)(F)Oc5cc(F)c(F)c(F)c5)c(F)c4)c(F)c3)cc2C1] |
| | 3CPPC3 | 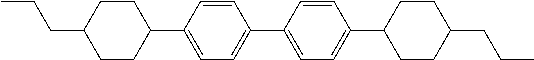 [SMILES: CCCC1CCC(c2ccc(-c3ccc(C4CCC(CCC)CC4)cc3)cc2)CC1] |

The sources of the liquid-crystal compositions are shown in Table 3 below.

TABLE 3

| | Code name | Manufacturer/Self-made |
|---|---|---|
| Formula (I) | 3PGUQUF | Purchased from Jiangsu Hecheng New material Corp. |
| | 4PGUQUF | Purchased from Jiangsu Hecheng New material Corp. |
| | 5PGUQUF | Purchased from Jiangsu Hecheng New material Corp. |
| | 3PGUQKF | Purchased from Beijing Bayishikong Liquid-Crystal Material |
| | | Technology Co., Ltd. |
| | 3APUQKF | Purchased from Beijing Bayishikong Liquid-Crystal Material |
| | | Technology Co., Ltd. |
| | 5doPUQUF | Purchased from Beijing Bayishikong Liquid-Crystal Material |
| | | Technology Co., Ltd. (Taiwan Pat. No. 1542669) |
| Formula | V2PTP2V | Purchased from Beijing Bayishikong Liquid-Crystal Material |
| (II) | | Technology Co., Ltd. |
| Other | 1PTPO2 | Purchased from Jiangsu Hecheng New material Corp. |
| Component | 3PTPO1 | Purchased from Jiangsu Hecheng New material Corp. |
| | 3PTPO2 | Purchased from Jiangsu Hecheng New material Corp. |
| Formula | 5PP1 | Purchased from Beijing Bayishikong Liquid-Crystal Material |
| (III) | | Technology Co., Ltd. |
| | 3CPO2 | Purchased from Jiangsu Hecheng New material Corp. |
| | 3CC2 | Purchased from Jiangsu Hecheng New material Corp. |
| | 3CCV1 | Purchased from Beijing Bayishikong Liquid-Crystal Material |
| | | Technology Co., Ltd. |
| | 5CCV | Purchased from Jiangsu Hecheng New material Corp. |
| | 3CCV | Purchased from Beijing Bayishikong Liquid-Crystal Material |
| | | Technology Co., Ltd. |
| Formula | 3PUQKF | Purchased from Beijing Bayishikong Liquid-Crystal Material |
| (IV) | | Technology Co., Ltd. |
| | 2toUQUO2F | Made in accordance with the method of Taiwan Pat. I509058 |
| | 2doPUO2F | Purchased from Beijing Bayishikong Liquid-Crystal Material |
| | | Technology Co., Ltd. (Taiwan Pat. No. I542669) |
| | 3doPUO2F | Purchased from Beijing Bayishikong Liquid-Crystal Material |
| | | Technology Co., Ltd. (Taiwan Pat. No. I542669) |
| | 2CPGF | Purchased from Jiangsu Hecheng New material Corp. |
| | 3CPGF | Purchased from Jiangsu Hecheng New material Corp. |
| | 5CPGF | Purchased from Jiangsu Hecheng New material Corp. |
| | VCCGF | Purchased from Jiangsu Hecheng New material Corp. |
| | 2CCGF | Purchased from Jiangsu Hecheng New material Corp. |
| | 3CCGF | Purchased from Jiangsu Hecheng New material Corp. |
| | 5CCGF | Purchased from Jiangsu Hecheng New material Corp. |
| | 2CCUF | Purchased from Jiangsu Hecheng New material Corp. |
| | 3CCUF | Purchased from Jiangsu Hecheng New material Corp. |
| | 5CCUF | Purchased from Jiangsu Hecheng New material Corp. |
| | 3CCPOCF3 | Purchased from Jiangsu Hecheng New material Corp. |
| | 5CCPOCF3 | Purchased from Jiangsu Hecheng New material Corp. |
| | 3CPPF | Purchased from Jiangsu Hecheng New material Corp. |
| | 3CPP2 | Purchased from Jiangsu Hecheng New material Corp. |
| | 4CCP3 | Purchased from Jiangsu Hecheng New material Corp. |
| | 3CPTP2 | Purchased from Beijing Bayishikong Liquid-crystal Material |
| | | Technology Co., Ltd. |
| Formula | 3CCPGF | Purchased from Jiangsu Hecheng New material Corp. |
| (V) | 5CCPGF | Purchased from Jiangsu Hecheng New material Corp. |
| | 2RIGUQUF | Purchased from Jiangsu Hecheng New material Corp. |
| | | (Taiwan Pat. No. I462993) |
| | 3RIGUQUF | Purchased from Jiangsu Hecheng New material Corp. |
| | | (Taiwan Pat. No. I462993) |
| | 3CPPC3 | Purchased from Jiangsu Hecheng New material Corp. |

The liquid-crystal composition of each Example and Comparative Example in the present disclosure is obtained by mixing the components in the amount listed in Table 4 under room temperature (about 25° C.), and then heating the mixture to slightly higher than the clearing point to sufficiently dissolve and uniformly mix the components. The characteristics of the liquid-crystal composition of each Example and Comparative Example in the present disclosure are measured and the results are summarized in Table 4 below. In Table 4, the Examples are numbered M1, M2, M3, M4, and M5; the Comparative Examples are numbered E1, E2 and E3. It should be noted that the unit of the content of the liquid-crystal composition in Table 4 is wt % (based on the total weight of the liquid-crystal composition).

Then, the properties (clearing point (Tni), dielectric anisotropy (Δε), rotational viscosity coefficient (γ1), refractive anisotropy (Δn), voltage holding ratio before being exposed to UV light (VHR), voltage holding ratio after being exposed to UV light (UV VHR), and low-temperature storage (LTS) period) of the liquid-crystal compositions of each Example and Comparative Example are measured and the results are summarized in Table 5 below. The properties of these liquid-crystal compositions are measured by the methods described below.

Clearing Point (or Nematic-Isotropic Phase Transition Temperature (Tni), the Unit: ° C.)

The liquid-crystal composition was loaded into an aluminum plate and weighed 0.5 mg to 10 mg. The liquid-crystal composition was compressed to form a tablet in the aluminum plate, and then a phase transition temperature measurement was conducted by a differential scanning calorimetry (DSC). The phase transition temperature measurement is a method of obtaining the phase transition temperature by measuring the starting point of an endothermic peak and the starting point of the exothermic peak of the liquid-crystal composition, wherein the endothermic peak and the exothermic peak are a result of the phase transition of the liquid-crystal composition. Since the liquid-crystal composition is a nematic phase, the plot of the temperature raised from room temperature will have an endothermic peak, which means that the nematic phase has become a liquid phase. Thus, the clearing temperature (Tni) can be read from the plot.

Dielectric Anisotropy (Δε)

The liquid-crystal compound was loaded into a liquid-crystal cell. The voltage of 0V to 20V was applied to the liquid-crystal cell at 25° C. and the curve of capacitance against voltage (C-V curve) was measured. Both the high voltage area and the low voltage area of the C-V curve will show a horizontal line. Capacitance C⊥ was measured in the low voltage area; Capacitance C∥ was measured in the high voltage area. The C⊥ and C∥ can be converted to dielectric constant ε⊥ and dielectric constant ε∥ using a mathematical formula. Dielectric anisotropy (Δε) is equal to the difference between C⊥ and C∥ (Δε=ε∥−ε⊥).

Rotational Viscosity Coefficient (γ1, the Unit: mPa·s)

After obtaining the dielectric anisotropy (Δε) using the method described above, it can be converted into the rotational viscosity coefficient (γ1) using software.

Refractive Anisotropy (Δn)

Each of the liquid-crystal composition was measured by an Abbe refractometer (ATAGO, DR-M2) having a polarizing plate on its eyepiece. First, an alignment solution was rubbed on to the surface of a main prism in the Abbe refractometer along a single direction and the surface was wiped by a dust-free cloth along the same direction. Then, a small amount of the liquid-crystal compound was dropped onto the main prism. The refractive anisotropy measurement was performed at 25° C. with a wavelength of 598 nm filter. When the polarization direction was parallel to the direction of wiping, the refractive index was measured as nil; and when wiping direction was perpendicular to the polarization direction, the refractive index was measured as n⊥. Refractive index anisotropy (Δn) is equal to the difference value between n∥ and n⊥ (Δn=n∥−n⊥).

Voltage Holding Ratio (VHR)

At an environmental temperature of 60° C., a direct current (the charge voltage was 1V, the operation frequency was 0.6 Hz, and the pulse width was 1667 msec) was applied to each liquid-crystal display device containing the each liquid-crystal composition of Examples and Comparative Examples to measure the voltage holding ratio of each liquid-crystal display device. Specifically, extremely low current and leak voltage were measured using a liquid-crystal parameter-measuring instrument (ALCT-IV1, INSTEC) to assess the voltage holding ratio when the voltage is under 1V.

The original voltage holding ratio of the liquid-crystal display device is defined as VHR. The voltage holding ratio after being exposed to UV light is defined as UV VHR. The light stability of the liquid-crystal display device was assessed by the difference between VHR and UV VHR (ΔVHR). The smaller the ΔVHR is, the better light stability the liquid-crystal display device possess.

Low-Temperature Storage (LTS, the Unit: Day)

0.3 g the liquid-crystal composition was added into a 7 ml glass flask, and the flask was placed in a −30° C. constant low temperature freezer. The day(s) that the liquid-crystal composition takes to form crystal precipitate is the day(s) of the low temperature storage. The more days it takes, the better LTS the liquid-crystal composition possess.

TABLE 4

| | | | | | | | Comparative | Comparative | Comparative |
|---|---|---|---|---|---|---|---|---|---|
| | | Example | Example | Example | Example | Example | Example | Example | Example |
| | | M1 | M2 | M3 | M4 | M5 | E1 | E2 | E3 |
| First | 3PGUQUF | 5 | 5 | 0 | 0 | 0 | 0 | 5.5 | 0 |
| component | 4PGUQUF | 0 | 5 | 0 | 4 | 0 | 0 | 0 | 0 |
| | 5PGUQUF | 5 | 5 | 2 | 0 | 5 | 0 | 0 | 0 |
| | 3PGUQKF | 10 | 0 | 0 | 4 | 5 | 0 | 0 | 0 |
| | 3APUQKF | 0 | 0 | 8 | 0 | 0 | 0 | 0 | 0 |
| | 5doPUQUF | 0 | 0 | 0 | 4 | 0 | 0 | 0 | 0 |
| Second | V2PTP2V | 10 | 13 | 8 | 2 | 8 | 10 | 0 | 13 |
| component | | | | | | | | | |
| Other | 1PTPO2 | 0 | 0 | 0 | 0 | 0 | 0 | 3 | 0 |
| component | 3PTPO1 | 0 | 0 | 0 | 0 | 0 | 0 | 3 | 0 |
| | 3PTPO2 | 0 | 0 | 0 | 0 | 0 | 0 | 0 | 3 |
| Third | 5PP1 | 0 | 0 | 14 | 0 | 0 | 0 | 0 | 0 |
| component | 3CPO2 | 0 | 0 | 0 | 10 | 0 | 0 | 0 | 0 |
| | 3CC2 | 0 | 0 | 0 | 15 | 0 | 0 | 0 | 0 |
| | 3CCV1 | 0 | 0 | 5 | 6 | 0 | 0 | 0 | 0 |
| | 5CCV | 0 | 14 | 0 | 0 | 0 | 0 | 0 | 0 |
| | 3CCV | 40 | 40 | 25 | 30 | 50 | 33 | 37 | 42 |
| Fourth | 3PUQKF | 0 | 0 | 0 | 5 | 0 | 0 | 0 | 0 |
| component | 2toUQUO2F | 0 | 0 | 0 | 0 | 0 | 8 | 0 | 0 |
| | 2doPUO2F | 0 | 0 | 0 | 0 | 0 | 3.5 | 4 | 5.5 |
| | 3doPUO2F | 0 | 0 | 0 | 0 | 0 | 3.5 | 4 | 5.5 |
| | 2CPGF | 0 | 4 | 0 | 0 | 0 | 0 | 0 | 0 |
| | 3CPGF | 0 | 4 | 0 | 0 | 0 | 0 | 0 | 0 |
| | 5CPGF | 0 | 5 | 0 | 0 | 0 | 0 | 0 | 0 |
| | VCCGF | 0 | 5 | 0 | 0 | 0 | 0 | 0 | 0 |
| | 2CCUF | 7 | 0 | 10 | 5 | 6 | 6.5 | 6.5 | 0 |
| | 3CCUF | 7 | 0 | 0 | 0 | 6 | 6.5 | 6.5 | 0 |
| | 5CCUF | 7 | 0 | 0 | 0 | 6 | 6.5 | 6.5 | 0 |
| | 5CCPOCF3 | 0 | 0 | 0 | 10 | 0 | 0 | 0 | 5 |
| | 3CPPF | 0 | 0 | 8 | 0 | 0 | 0 | 0 | 0 |
| | 3CPP2 | 0 | 0 | 10 | 0 | 0 | 0 | 0 | 0 |
| | 4CCP3 | 0 | 0 | 0 | 5 | 0 | 0 | 0 | 0 |
| | 3CPTP2 | 0 | 0 | 8 | 0 | 0 | 0 | 0 | 0 |
| Fifth | 3CCPGF | 9 | 0 | 0 | 0 | 9 | 10 | 10.5 | 7.5 |
| component | 5CCPGF | 0 | 0 | 0 | 0 | 0 | 10 | 8 | 7.5 |
| | 2RIGUQUF | 0 | 0 | 0 | 0 | 0 | 0 | 0 | 5 |
| | 3RIGUQUF | 0 | 0 | 0 | 0 | 5 | 0 | 5.5 | 6 |
| | 3CPPC3 | 0 | 0 | 2 | 0 | 0 | 2.5 | 0 | 0 |

| | | | | | | | | |
|---|---|---|---|---|---|---|---|---|
| Total (wt %) | 100 | 100 | 100 | 100 | 100 | 100 | 100 | 100 |
| Content of the first | 20 | 15 | 10 | 12 | 10 | 0 | 5.5 | 0 |
| component (wt %) | | | | | | | | |
| Content of the second | 10 | 13 | 8 | 2 | 8 | 10 | 0 | 13 |
| component (wt %) | | | | | | | | |
| Content of the third | 40 | 54 | 44 | 61 | 50 | 33 | 37 | 42 |
| component (wt %) | | | | | | | | |
| Content of the fourth | 21 | 18 | 36 | 25 | 18 | 34.5 | 27.5 | 16 |
| component (wt %) | | | | | | | | |
| Content of the fifth | 9 | 0 | 2 | 0 | 14 | 22.5 | 24 | 26 |
| component (wt %) | | | | | | | | |
| Content of the other | 0 | 0 | 0 | 0 | 0 | 0 | 6 | 3 |
| component (wt %) | | | | | | | | |

TABLE 5

| | | | | | | | Comparative | Comparative | Comparative |
|---|---|---|---|---|---|---|---|---|---|
| | | Example | Example | Example | Example | Example | Example | Example | Example |
| | | M1 | M2 | M3 | M4 | M5 | E1 | E2 | E3 |
| Properties | Tni | 84 | 63 | 81 | 65 | 79 | Precipitate | 103 | 92 |
| | Δε | 7.57 | 3.88 | 3.58 | 4.33 | 5.03 | at room | 7.82 | 5.76 |
| | γ1 | 63 | 34 | 55 | 39 | 46 | temperature | 96 | 68 |
| | Δn | 0.116 | 0.108 | 0.136 | 0.079 | 0.102 | | 0.115 | 0.131 |
| | VHR | 94.1 | 92.9 | 97.9 | 95.8 | 95.4 | | 95.9 | 98.6 |
| | UV VHR | 89.5 | 89.6 | 97.2 | 92.9 | 92.2 | | 73.1 | 93.3 |
| | ΔVHR | 4.6 | 3.3 | 0.7 | 2.9 | 3.2 | | 22.8 | 5.3 |
| | LTS (−30° C.) | 25 days | <1 day | <1 day | 1 day | 18 days | | 1 day | 1 day |

As shown in Table 4 and Table 5, since the liquid-crystal compositions of Examples M1-M5 contain the compound represented by Formula (I) and the compound represented by Formula (II) at the same time, the liquid-crystal compositions not only have a higher dielectric anisotropy (Δε) and a lower rotational viscosity (γ1), but also possess better light stability. Therefore, the liquid-crystal composition of the present disclosure not only may fulfill the need of low threshold voltage and high response speed but maintain the quality and stability of the liquid-crystal display device under various circumstances as well.

For example, besides having a higher dielectric anisotropy (Δε) and a lower rotational viscosity (γ1), since the liquid-crystal compositions of Examples M1 and M5 include a fifth component containing a compound having a structure unit G, it can be observed that the low-temperature storage is further improved compared to that of Examples M2-M4 (wherein the fifth component does not contain a compound having a structure unit G).

On the other hand, besides having a higher dielectric anisotropy (Δε) and a lower rotational viscosity (γ1), since the third component of the liquid-crystal compositions of Examples M2, M3 and M4 contains two or more compounds represented by Formula (III) and the content of the third component of the liquid-crystal composition in Example M5 is greater than 40 wt %, the light stability of the liquid-crystal compositions in Examples M2-M5 is further improved comparing to that of Comparative Example E1 (wherein the third component only contains one compound represented by Formula (III) or the content of the third component is equal to or smaller than 40 wt %). In addition, since the third component of the liquid-crystal composition in Example M3 includes 3CCV1 and 3CCV, which have two cyclohexane structure, and 5PP1, which has two benzene structures; the third component of the liquid-crystal composition in Example M4 includes 3CCV1, 3CCV and 3CC2, which have two cyclohexane structures, and 3CPO2, which has one benzene structure, the stability of the liquid-crystal compositions of Examples M3 and M4 is superior.

Conversely, since the liquid-crystal composition of Comparative Example E1 does not include a compound represented by Formula (I), the liquid-crystal composition precipitates crystals at room temperature, which makes it unsuitable for use.

Since the liquid-crystal composition of Comparative Example E2 does not include a compound represented by Formula (II), the rotational viscosity (γ1) of the liquid-crystal composition is apparently higher, which means the liquid-crystal composition may not achieve a higher dielectric anisotropy (Δε) and a lower rotational viscosity (γ1) simultaneously. Moreover, it can be observed that the liquid-crystal composition of Comparative Example E2 possesses a poor light stability.

Because the liquid-crystal composition of Comparative Example E3 does not include a compound represented by Formula (I), the rotational viscosity (γ1) of the liquid-crystal composition is apparently higher, which means the liquid-crystal composition may not achieve a higher dielectric anisotropy (Δε) and a lower rotational viscosity (γ1) simultaneously. Moreover, it can be observed that the liquid-crystal composition of Comparative Example E3 possesses a poor light stability.

In summary, the liquid-crystal compositions provided in the present disclosure not only have a clearing point, refractive anisotropy that comply with the industry requirements but also possess a better dielectric anisotropy, rotational viscosity, light stability and/or low temperature storage. Therefore, it can be expected that utilizing the liquid-crystal composition including the compound represented by Formula (I) and the compound represented by Formula (II) at the same time in a liquid-crystal display device may not only achieve the object of power saving and enhancing the response speed of the liquid-crystal molecule but also improve the quality and performance of the liquid-crystal display device.

Although some embodiments of the present disclosure and their advantages have been described in detail, it should be understood that various changes, substitutions and alterations can be made herein without departing from the spirit and scope of the disclosure as defined by the appended claims. For example, it will be readily understood by one of ordinary skill in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure.

What is claimed is:

1. A liquid-crystal composition comprises a first component and a second component, wherein the first component comprises one or more compounds represented by Formula (I) and the second component comprises one or more compounds represented by Formula (II): 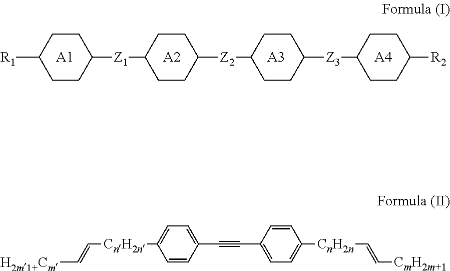
wherein R₁ and R₂ are independently F, a C₁-C₁₀ alkyl group, a C₁-C₁₀ alkoxy group, a C₂-C₁₀ alkenyl group, a C₂-C₁₀ alkenyloxy, or a C₂-C₁₀ alkynyl group, where the C₁-C₁₀ alkyl group, the C₁-C₁₀ alkoxy group, the C₂-C₁₀ alkenyl group, the C₂-C₁₀ alkenyloxy, or the C₂-C₁₀ alkynyl group is unsubstituted or at least one —CH₂— thereof is substituted by —O—, —NH—, —S—, —CO—, —O—CO—, —CO—O— or —O—CO—O—, provided that the —O—, —NH—, —S—, —CO—, —O—CO—, —CO—O— or —O—CO—O— do not directly bond to one another, and/or at least one hydrogen of the C₁-C₁₀ alkyl group, the C₁-C₁₀ alkoxy group, the C₂-C₁₀ alkenyl group, the C₂-C₁₀ alkenyloxy, or the C₂-C₁₀ alkynyl group is unsubstituted or substituted by halogen, CN, or CF₃;
each of A1, A2, A3, and A4 independently represents (i) an unsubstituted 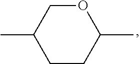
(ii) a substituted 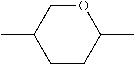
where at least one —CH₂— thereof is substituted by —O—, —NH—, —S—, —CO—, —O—CO—, —CO—O— or —O—CO—O— and the —O—, —NH—, —S—, —CO—, —O—CO—, —CO—O— or —O—CO—O— do not directly bond to one another, (iii) a substituted 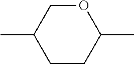
where at least one hydrogen thereof is substituted by halogen, CN, or CF₃, (iv) an unsubstituted 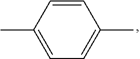
(v) a substituted 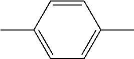
where at least one hydrogen thereof is substituted by halogen, CH₃, CN, or CF₃, (vi) a substituted 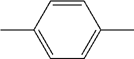
where at least one —CH— thereof is substituted by —N—, (vii) an unsubstituted 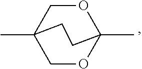
and/or (viii) a substituted 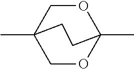
where at least one —CH₂— thereof is substituted by —O—, —NH—, —S—, —CO—, —O—CO—, —CO—O— or —O—CO—O— and the —O—, —NH—, —S—, —CO—, —O—CO—, —CO—O— or —O—CO—O— do not directly bond to one another; A1, A2, A3, and A4 are the same or different;
each of Z₁, Z₂, and Z₃ independently represents a single bond, —CF₂—O—, —O—CF₂—, —CO—O—, or —O—CO—, and at least one of Z₁, Z₂, and Z₃ is —CF₂—O— or —O—CF₂—; and
each of the m, m′, n and n′ independently represents an integer from 0 to 6, wherein the m, m′, n and n′ are the same or different.

2. The liquid-crystal composition as claimed in claim 1, further comprising:
a component selected from the group consisting of a third component, a fourth component, a fifth component and a combination thereof,
wherein the third component comprises one or more compounds represented by Formula (III): 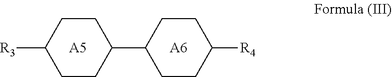
wherein each of R₃ and R₄ independently represents F, a C₁-C₁₀ alkyl group, a C₁-C₁₀ alkoxy group, a C₂-C₁₀ alkenyl group, a C₂-C₁₀ alkenyloxy, or a C₂-C₁₀ alkynyl group, wherein the C₁-C₁₀ alkyl group, the C₁-C₁₀ alkoxy group, the C₂-C₁₀ alkenyl group, the C₂-C₁₀ alkenyloxy, or the C₂-C₁₀ alkynyl group is unsubstituted or at least one —CH₂— thereof is substituted by —O—, —NH—, —S—, —CO—, —O—CO—, —CO—O— or —O—CO—O—, provided that the —O—, —NH—, —S—, —CO—, —O—CO—, —CO—O— or —O—CO—O— do not directly bond to one another, and/or at least one hydrogen of the C₁-C₁₀ alkyl group, the C₁-C₁₀ alkoxy group, the C₂-C₁₀ alkenyl group, the C₂-C₁₀ alkenyloxy, or the C₂-C₁₀ alkynyl group is unsubstituted or substituted by halogen, CN, or CF₃;
each of A5 and A6 independently represents (i) an unsubstituted 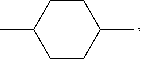
(ii) a substituted 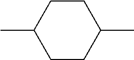
where at least one —CH₂— thereof is substituted by —O—, —NH—, —S—, —CO—, —O—CO—, —CO—O— or —O—CO—O— and the —O—, —NH—, —S—, —CO—, —O—CO—, —CO—O— or —O—CO—O— do not directly bond to one another, (iii) an unsubstituted 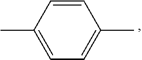
(iv) a substituted 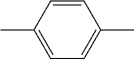
where at least one hydrogen thereof is substituted by halogen, CH₃, CN, or CF₃, (v) a substituted 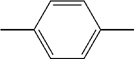
where at least one —CH— thereof is substituted by —N—, (vi) an unsubstituted 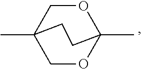
and/or (vii) a substituted 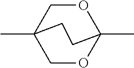
where at least one —CH₂— thereof is substituted by —O—, —NH—, —S—, —CO—, —O—CO—, —CO—O— or —O—CO—O— and the —O—, —NH—, —S—, —CO—, —O—CO—, —CO—O— or —O—CO—O— do not directly bond to one another; A5 and A6 are the same or different;
wherein the fourth component comprises one or more compounds represented by Formula (IV): 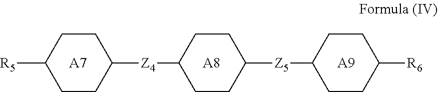
wherein the fifth component comprises one or more compounds represented by Formula (V): 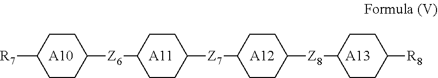
wherein each of R₅, R₆, R₇ and R₈ independently represents F, a C₁-C₁₀ alkyl group, a C₁-C₁₀ alkoxy group, a C₂-C₁₀ alkenyl group, a C₂-C₁₀ alkenyloxy, or a C₂-C₁₀ alkynyl group, where the C₁-C₁₀ alkyl group, the C₁-C₁₀ alkoxy group, the C₂-C₁₀ alkenyl group, the C₂-C₁₀ alkenyloxy, or the C₂-C₁₀ alkynyl group is unsubstituted or at least one —CH₂— thereof is substituted by —O—, —NH—, —S—, —CO—, —O—CO—, —CO—O— or —O—CO—O—, provided that the —O—, —NH—, —S—, —CO—, —O—CO—, —CO—O— or —O—CO—O— do not directly bond to one another, and/or at least one hydrogen of the C₁-C₁₀ alkyl group, the C₁-C₁₀ alkoxy group, the C₂-C₁₀ alkenyl group, the C₂-C₁₀ alkenyloxy, or the C₂-C₁₀ alkynyl group is unsubstituted or substituted by halogen, CN, or CF₃;
each of A7, A8, A9, A10, A11, A12 and A13 independently represents (i) an unsubstituted 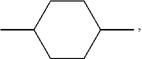
(ii) a substituted 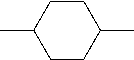
where at least one —CH₂— thereof is substituted by —O—, —NH—, —S—, —CO—, —O—CO—, —CO—O— or —O—CO—O— and the —O—, —NH—, —S—, —CO—, —O—CO—, —CO—O— or —O—CO—O— do not directly bond to one another, (iii) a substituted 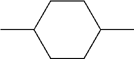
where at least one hydrogen thereof is substituted by halogen, CN, or CF₃, (iv) an unsubstituted 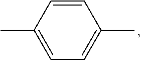
(v) a substituted 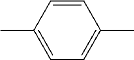
where at least one hydrogen is substituted by halogen, CH₃, CN, or CF₃, (vi) a substituted 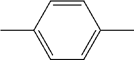
where at least one —CH— thereof is substituted by —N—, (vii) an unsubstituted 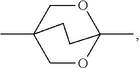
(viii) a substituted 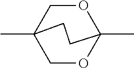
where at least one —CH₂— is substituted by —O—, —NH—, —S—, —CO—, —O—CO—, —CO—O— or —O—CO—O— and the —O—, —NH—, —S—, —CO—, —O—CO—, —CO—O— or —O—CO—O— do not directly bond to one another, (viiii) a substituted 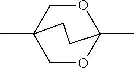
where at least one hydrogen thereof is substituted by halogen, CN, or CF₃, and/or (x) an unsubstituted 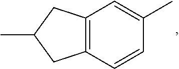
(xi) a substituted 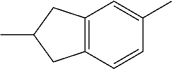
where at least one —CH₂— thereof is substituted by —O—, —NH—, —S—, —CO—, —O—CO—, —CO—O— or —O—CO—O— and the —O—, —NH—, —S—, —CO—, —O—CO—, —CO—O— or —O—CO—O— do not directly bond to one another, and/or (xii) a substituted 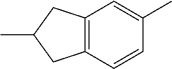
where at least one hydrogen thereof is substituted by halogen, CN, or CF₃, wherein A7, A8, A9, A10, A11, A12, and A13 are the same or different; and
each of Z₄, Z₅, Z₆, Z₇ and Z₈ independently represents a single bond, a double bond, a triple bond, —(CH₂)₂—, —CF₂—O—, —O—CF₂—, —CO—O—, or —O—CO—;
wherein when one of Z₆, Z₇ and Z₈ is —CF₂—O— or —O—CF₂—, one of A10, A11, A12, and A13 is (i) an unsubstituted or 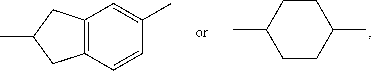
(ii) a substituted 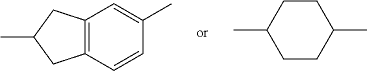
where at least one —CH₂— thereof is substituted by —O—, —NH—, —S—, —CO—, —O—CO—, —CO—O— or —O—CO—O— and the —O—, —NH—, —S—, —CO—, —O—CO—, —CO—O— or —O—CO—O— do not directly bond to one another, or (iii) a substituted 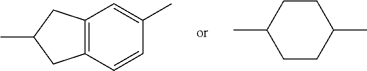
where at least one hydrogen thereof is substituted by halogen, CN, or CF₃.

3. The liquid-crystal composition as claimed in claim 2, wherein the liquid-crystal composition comprises the fifth component, and at least one of A10, A11, A12, and A13 is 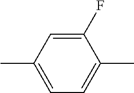
in the one or more compounds represented by Formula (V).

4. The liquid-crystal composition as claimed in claim 2, wherein the liquid-crystal composition comprises the third component.

5. The liquid-crystal composition as claimed in claim 4, wherein the third component is 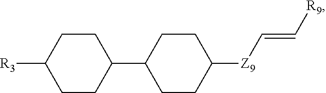
and wherein R₉ is a C₁-C₆ alkyl group, Z₉ is a single bond, —(CH₂)₂—, or —CH₂—, or at least one of A5 and A6 of Formula (III) is an unsubstituted

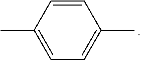

6. The liquid-crystal composition as claimed in claim 4, wherein the third component comprises two or more compounds represented by Formula (III).

7. The liquid-crystal composition as claimed in claim 2, wherein the liquid-crystal composition comprises 5-50% wt % of the fourth component, based on a total weight of the liquid-crystal composition.

8. The liquid-crystal composition as claimed in claim 1, wherein Z₃ is —CF₂—O— or —O—CF₂—.

9. The liquid-crystal composition as claimed in claim 1, wherein the first component comprises two or more compounds represented by Formula (I).

10. The liquid-crystal composition as claimed in claim 2, wherein the liquid-crystal composition comprises 0.1-35 wt % of the first component, 0.1-20 wt % of the second component, 0-65 wt % of the third component, 0-50 wt % of the fourth component and 0-15 wt % of the fifth component, based on a total weight of the liquid-crystal composition.

11. The liquid-crystal composition as claimed in claim 1, wherein a dielectric anisotropy (Δε) of the liquid-crystal composition is greater than 2 and a difference between a VHR and a UV VHR (ΔVHR) of the liquid-crystal composition is equal to or smaller than 15%.

12. A liquid-crystal display device, comprising:
a first substrate;
a second substrate disposed opposite the first substrate;
a liquid-crystal layer disposed between the first substrate and the second substrate, wherein the liquid-crystal layer comprises the liquid-crystal composition as claimed in claim 11.
